(19) United States
(12) Patent Application Publication
(10) Pub. No.: US 2011/0269934 A1
(43) Pub. Date: Nov. 3, 2011

(54) PRODUCTION METHOD AND APPARATUS FOR POLYTRIMETHYLENE TEREPHTHALATE

(76) Inventors: Toshiaki MATSUO, Mito (JP); Kenichiro Oka, Mito (JP); Masayuki Kamikawa, Hitachinaka (JP); Takeyuki Kondo, Hitachi (JP); Hiroyuki Ito, Tokyo (JP); Yasunari Sase, Tokyo (JP); Masashi Tanto, Tokyo (JP)

(21) Appl. No.: 13/094,929

(22) Filed: Apr. 27, 2011

(30) Foreign Application Priority Data
Apr. 28, 2010 (JP) 2010-103782

(51) Int. Cl. C08G 63/80; B01J 19/18

(52) U.S. Cl. 528/308.8; 422/109

(57) ABSTRACT

An object of the present invention is to provide a reasonable polycondensation step by which an appropriate molecular weight can be obtained and material decomposition associated with thermolysis can be suppressed, so as to contribute to production technology for PTT polymers. The production method for polytrimethylene terephthalate comprises an esterification step and a polycondensation step, wherein the polycondensation step is divided into multiple stages, polycondensation is performed using a polymerization vessel having a twin-shaft agitator in the final stage of the polycondensation step, and the polymerization temperature during the subsequent stage of the polycondensation step is less than the polymerization temperature during the former stage of the polycondensation step.

### BACKGROUND OF THE INVENTION

1. Field of the Invention

The present invention relates to a production method and a production apparatus for polytrimethylene terephthalate wherein pure terephthalic acid and 1,3-propanediol are main raw materials.

2. Background Art

Polytrimethylene terephthalate (hereinafter, PTT) is a polyester used for high-grade fiber, in which pure terephthalic acid (hereinafter, PTA), which is a kind of dibasic acid, and 1,3-propanediol (hereinafter, PDO), which is a kind of glycol, are the main raw materials. In recent years, in view of departure from dependence on oil, biomass-derived polyester has attracted attention as an alternative material for commodity plastics produced from a petroleum-derived substance such as polypropylene or polyethylene. Also regarding PTT, PDO has often been synthesized from a biomass-derived raw material in recent years, indicating that PTT has similar aspects to those of biomass-derived plastics.

PTT is synthesized through an esterification reaction between glycol (PDO) and dibasic acid (PTA), as explained below, and a polycondensation through a transesterification reaction of the resulting oligomers. An esterification reaction is a binding reaction between a carboxyl-end group of dibasic acid and a hydroxyl-end group of glycol, which takes place under normal pressure or weak negative pressure, and an atmosphere of an inert gas such as nitrogen. Water is thus generated as a byproduct (formula 1). Therefore, water is removed by degassing, and thus the reaction is accelerated. A polymerization catalyst is added as necessary, so as to accelerate the reaction. Also, a polycondensation reaction takes place between oligomers formed as a result of an esterification reaction in the presence of a polymerization catalyst under a reduced-pressure environment, by which a terminal glycol is liberated from one oligomer, following which the oligomer thus binds to the terminal glycol of the other oligomer. Glycol is generated as a byproduct (formula 2), the byproduct is removed by degassing to accelerate the reaction, and thus, the degree of polymerization has increased. The required degree of polymerization in the case of use for fiber, which is a major application, is said to be about 18,000 to 22,000 in terms of number average molecular weight (Non-patent document 1).

2HO—(CH₂)₃—OH+HOCO—(C₆H₄)—COOH→HO—(CH₂)₃—OCO—(C₆H₄)—COO—(CH₂)₃—OH+2H₂O↑ [Chemical formula 1]

HO—{(CH₂)₃—OCO—(C₆H₄)—CO}ₓ—O(CH₂)₃—OH+HO—{(CH₂)₃—OCO—(C₆H₄)—CO}_{y}—O—(CH₂)₃—OH→HO—{(CH₂)₃—OCO—(C₆H₄)—CO}_{x+y}—O—(CH₂)₃—OH+HO—(CH₂)₃—OH↑ [Chemical formula 2]

In the above esterification reaction, raw-material glycol may decomposed. In particular, when glycol is PDO, generation of acrolein as represented by formula 3 tends to take place. Such side reactions cause a decrease in raw material yield, so that it is desirable to suppress them to as great an extent as possible.

HO—(CH₂)₃—OH→CH₂═CH—CHO+H₂+H₂O↑ [Chemical formula 3]

Regarding the PTT polymerization process, various methods have been conventionally proposed (Patent documents 1-4). For example, esterification reaction conditions comprise, under an environment of inert atmosphere at atmospheric pressure, temperatures ranging from 220° C. to 240° C., time periods ranging from 1.5 h to 4 h, and catalyst concentrations ranging from 150 ppm to 1000 ppm in terms of titanium atoms. Also, polycondensation reaction conditions comprise, under a reduced-pressure (0.2 torr to 0.8 torr) environment, temperatures ranging from 250° C. to 270° C., time periods ranging from 2 h to 3.67 h, and catalyst concentrations ranging from 24 ppm to 2000 ppm in terms of titanium atoms. Note that in all of these cases, a polycondensation reaction is performed via single-step melt polymerization under a single type of conditions. Thereafter, a step of solid-state polymerization is introduced as necessary. Solid-state polymerization generally has advantages in that it is performed at a lower temperature than that of polycondensation in a melt state and is less affected by thermolysis, but it has disadvantages such as extremely increased polymerization time, increased facility scale, and increased operating cost. The reason for introduction of a solid-state polymerization step into a PTT polymerization step is that, unlike the case of other polyesters, PTT rapidly undergoes thermolysis, particularly at the final phase of the polycondensation step, and thus molecular weight and intrinsic viscosity can decrease.

Meanwhile, when no solid-state polymerization step is introduced, a polymer having a molecular weight suitable for practical use cannot always be obtained, since the polymer molecular chain growth has been halted. Specifically, whereas a temperature rise is required for suppressing an increase in viscosity with increased polymer molecular weight, the temperature rise increases the risk of thermolysis. Also, when polycondensation is continued without increasing the temperature, increased viscosity makes it difficult to remove the byproduct (PDO) generated by formula 2 above by degassing, so that the reaction reaches an equilibrium and stops. In particular, Patent document 4 describes that under conditions of polymerization temperature ranging from 180° C. to 260° C. and desirably ranging from 230° C. to 250° C. and polymerization time of 5 h or less, a polymer having an average degree of polymerization ranging from about 50 to 60 could be obtained. However, under such conditions, only a polymer having about half of the required average degree of polymerization or the required molecular weight can be obtained via polymerization.

Patent document 5 describes a case in which polycondensation is performed at temperatures ranging from about 240° C. to 250° C. for time periods ranging from 0.5 h to 1.5 h during the first half of the process and then at a temperature (250° C. or higher) higher than that used during the first half of the process for time periods ranging from 1 h to 2 h during the second half of the process. However, the document describes the molecular weight or intrinsic viscosity of an ideal polymerized product, but does not describe concerning the molecular weight or intrinsic viscosity of the thus obtained polymerized product. It is considered that under the conditions, a polymer having a sufficient molecular weight cannot be always obtained because of the short polymerization time.

Patent document 6 discloses: that polymerization in the first half of the process is performed at temperatures ranging from 250° C. to 270° C. for 2 h and then polymerization in the second half of the process is performed at temperatures ranging from 250° C. to 270° C. for time periods ranging from 1 h to 6 h; and a method using, in the second half of the process, a polymerization vessel having agitation blades of single-shaft cage type, basket type, disc type, or disc ring type, or a twin-shaft extruder (Twin Screw). A single-shaft polymerization vessel may be problematic in that a molten polymer increases in viscosity and thus increasingly adheres to the agitation blades and/or shafts, resulting in a lack of mixing effects (fluid sticking). Also, in the case of a twin-shaft extruder (in which the shafts rotate in the same direction), whereas the high surface renewal rate is effective for acceleration of the degassing of a byproduct, there are risks that sufficient acceleration of reaction would not be obtained, since large evaporation surface area cannot always be ensured, and that heat generation would take place due to shear force resulting from feeding effects, thereby causing thermolysis of the polymer due to temperature rise, for example.

Also, non-patent document 2 reports, concerning the thermolytic behavior of PTT, that as a thermolysis reaction proceeds, activation energy for the reaction decreases and the thermolysis reaction is accelerated. Generally, in the case of a thermolysis reaction, the higher the number of ester bond portions of a polymer, the higher the lysis point of the polymer. Therefore, the risk of thermolysis also increases. A phenomenon whereby thermolysis occurs at the final phase of the polycondensation step and then is accelerated, resulting in a rapid drop in molecular weight, is consistent with the content of non-patent document 1 above.

As described above, regarding PTT polymerization, it has been desired to develop technologies capable of inexpensively producing a polymer having an appropriate molecular weight and being suitable for use for fiber exhibiting suppressed material decomposition associated with thermolysis by reasonably proceeding with the polycondensation step without introduction of any solid-state polymerization step.

### PRIOR ART DOCUMENTS

### Patent Documents

Patent document 1: JP Patent Publication (Kokai) No. 51-140992 A (1976)
Patent document 2: JP Patent No. 3109053
Patent document 3: U.S. Pat. No. 5,798,433
Patent document 4: U.S. Pat. No. 5,599,900
Patent document 5: U.S. Pat. No. 6,538,076
Patent document 6: U.S. Pat. No. 7,196,159

### Non-Patent Documents

Non-patent document 1: B. Duh, J. Appl. Poly. Sci., Vol. 89, p. 3188-3200 (2003).
Non-patent document 2: X.-S. Wang, X.-G. In, D. Yan; J. Applied Polym. Sci., Vol. 84, p. 1600-1608 (2002).

### SUMMARY OF THE INVENTION

An object of the present invention is to provide a reasonable polycondensation step by which appropriate molecular weight can be obtained and material decomposition associated with thermolysis can be suppressed, thereby contributing to technology for producing PTT polymers.

The present inventors conducted detailed analysis concerning data described in non-patent document 2 and expressed the behavior-related data in an approximation formula (FIG. 1 and Table 1). As a result, it was revealed that at first, the activation energy and the frequency factor for a thermolysis reaction rapidly decreased as the rate of polymer weight decrease increased due to thermolysis and then slowly reached fixed levels. This suggests that the thermolysis reaction is composed of an initial primary lysis and the following secondary lysis. Also, based on the fact that overall thermolysis is accelerated by the secondary reaction, it is inferred that whereas primary lysis is pure cleavage of a polymer molecular chain (formula 4) due to heat, secondary lysis is cleavage of a polymer molecular chain (formula 5) due to effects exerted by products from primary lysis, such as acid catalysis of carboxyl terminal groups.

TABLE 1
Table 1 Activation energy and frequency
factor in thermolysis reaction

| Reaction | Primary | Secondary |
|---|---|---|
| Activation energyΔE_{≠} (kJ/mol · K) | 249.1 | 174.5 |
| In (Frequency factor k₀) (kg/mol · min) | 45.9 | 30.6 |

HO—{(CH₂)₃—OCO—(C₆H₄)—CO}ₓ—O—(CH₂)₃—OH→HO—{(CH₂)₃—OCO—(C₆H₄)—CO}_{y}—OH+HO—{(CH₂)₃—OCO—(C₆H₄)—CO}_{x-y}—OCH₂CH═CH₂ Chemical formula 4

HO—{(CH₂)₃—OCO—(C₆H₄)—CO}ₓ—O—(CH₂)₃—OH+H→HO—{(CH₂)₃—OCO—(C₆H₄)—CO}_{y}—OH+HO—{(CH₂)₃—OCO—(C₆H₄)—CO}_{x-y}—OCH₂CHCH₂CH₂⁺→HO—{(CH₂)₃—OCO—(C₆H₄)—CO}_{y}—OH+HO—{(CH₂)₃—OCO—(C₆H₄)—CO}_{x-y}—OCH₂CH═CH₂+H⁺ Chemical formula 5

Based on the above results, the present inventors have considered the following. Primary thermolysis should be absolutely suppressed to obtain PTT having an appropriate molecular weight while suppressing rapid thermolysis at the final phase of a polycondensation step. It is effective for this purpose to divide the polycondensation step into multiple stages, and the polymerization temperature during the subsequent stage of the polycondensation step is kept at a level lower than the polymerization temperature during the former stage of the polycondensation step.

Next, the present inventors have experimentally examined the Arrhenius plot concerning an esterification reaction and a polycondensation reaction upon PTT production in the presence of a titanium-based catalyst (FIGS. 2 and 3). As a result, results as shown in Table 2 were obtained for activation energy and frequency factor in each reaction.

TABLE 2
Table 2 Activation energy and frequency factor in each reaction

| | | Condensation |
|---|---|---|
| Reaction | Esterification | polymerization |
| Activation energy (kJ/mol · K) | 149.3 | 100.1 |
| Frequency factor (m³/mol · s · ppm) | 1.03 × 10⁵ | 0.31 |

Moreover, the present inventors examined esterification reactions at atmospheric pressure, 210° C., and catalyst concentration of 400 ppm in terms of titanium atoms, and thus confirmed that a sufficient esterification rate could be obtained with 3 hours of reaction. Subsequently, with the use of oligomers obtained by an esterification reaction, a flask experiment for PTT polymerization was conducted for 6 hours at various temperatures ranging from 250° C. to 270° C., a catalyst concentration of 1000 ppm in terms of titanium atoms, and pressure of 1 torr. In addition, regarding the correlation between catalyst concentration and time for polycondensation, since the reaction rate constant is proportional to catalyst concentration, an appropriate catalyst concentration can be selected to realize a desired polymerization time. As a result of the experiment, the present inventors discovered that: the molecular weight never increased at 270° C. due to vigorous thermolysis; the molecular weight increased to some extent at 260° C., but coloration of polymerized products in association with thermolysis was observed; no coloration was observed at 250° C.; and a polymer having an appropriate molecular weight (predicted from the Arrhenius plot) could be obtained via polymerization.

However, it was revealed that in the case of polymerization at a temperature of 250° C., the molecular weight increased almost proportionally to time as theorized for 5 to 6 hours after the start of reaction. However, thereafter the molecular weight never increased. As a reason for why the molecular weight never increased, failed degassing of byproducts in association with insufficient agitation capability was inferred. Specifically, as in formula 2 above, unless byproducts are removed from the system by degassing, a polycondensation reaction does not proceed. Actually, upon polymerization at such a temperature, it was confirmed that viscosity had rapidly increased at 5 to 6 hours after the start of reaction, and thus agitation speed was lowered. It was predicted, based on these results, that: at a temperature of 250° C., a polymerization reaction can proceed while suppressing thermolysis, but from 5 to 6 hours after the start of polymerization, viscosity rapidly increases; and thereafter, reaction is continued for about 5 hours using a polymerization vessel (hereinafter, horizontal twin-shaft polymerization vessel) equipped with a horizontal twin-shaft agitator for high viscosity such as a spectacle blade (Hitachi Plant Technologies, Ltd.), so that targeted high molecular weight can be achieved.

At this time, the later in the subsequent stage, the more increased the molecular weight and the more increased the risk of thermolysis. Hence, a gradual temperature decrease is desired. Also, a horizontal twin-shaft polymerization vessel has a function of causing two agitation shafts to rotate in a reverse direction from each other, so as to lift up and then extend the reaction solution (creation of evaporation surface area), and then folding and mixing the extended solution by allowing it to fall. At this time, a horizontal twin-shaft polymerization vessel relatively desired herein lacks any screw structure in the agitation blade and thus has no solution-feeding effects. Thus, it can keep the effects of heat generation due to shear force at a low level while ensuring the plug flowability of the reaction solution within the polymerization vessel. Thus, the polymerization vessel contributes to appropriate acceleration of a reaction and suppression of thermolysis. Based on the above findings, the present inventors completed the present invention. Specifically, the gist of the present invention is as follows.

(1) A production method for polytrimethylene terephthalate comprising an esterification step and a polycondensation step, wherein:
the polycondensation step is divided into multiple stages; polycondensation is performed with a polymerization vessel having a twin-shaft agitator during the final stage of the polycondensation step; and the polymerization temperature during the subsequent stage of the polycondensation step is lower than the polymerization temperature during the former stage of the polycondensation step.
(2) The production method for polytrimethylene terephthalate according to (1) above, wherein the polymerization temperature during the final stage of the polycondensation step is 250° C. or lower.
(3) The production method for polytrimethylene terephthalate according to (1) or (2) above, wherein the polymerization time during the final stage of the polycondensation step is 0.5 to 3.0 times and desirably 0.9 to 1.5 times the total polymerization time during the former stages of the polycondensation step.
(4) A production apparatus for polytrimethylene terephthalate comprising an esterification bath and polymerization vessels for performing polycondensation, wherein:
a plurality of polymerization vessels are serially connected;
a polymerization vessel in the final stage has a twin-shaft agitator; and
each polymerization vessel comprises a means for measuring the temperature of a molten polymer, a means for measuring the heating temperature of a polymerization vessel, and a means for controlling the heating temperature of a polymerization vessel so as to keep the temperature of a molten polymer at a predetermined level, and a means for controlling the temperature of a molten polymer in the polymerization vessel during the subsequent stage so that it is lower than the temperature of a molten polymer in the polymerization vessel during the former stage.
(5) The production apparatus for polytrimethylene terephthalate according to (4) above, wherein the means for controlling the heating temperature of the polymerization vessel during the final stage is to control the heating temperature of the polymerization vessel so that the temperature of the molten polymer is 250° C. or lower.
(6) The production apparatus for polytrimethylene terephthalate according to (4) or (5) above, wherein the volume of the charged molten polymer in the polymerization vessel during the final stage is 0.5 to 3.0 times and desirably 0.9 to 1.5 times the total volume of the charged molten polymer in the polymerization vessel during the former stages.

### Effect of the Invention

According to the present invention, PTT with suppressed coloration can be produced while ensuring that the PTT has the properties of fiber and the high molecular weight required for maintaining molding processability. Also, hazardous gas (acrolein) generation associated with thermal degradation of raw materials can be suppressed, so that improvement in raw material yield, reduction of environmental burdens, realization of modest exhaust gas treatment facilities, and cost reduction can be achieved.

### BRIEF DESCRIPTION OF THE DRAWINGS

FIG. 1 is a graph showing the correlation of weight reduction rate with activation energy and frequency factor in a thermolysis reaction as obtained by bibliographic data analysis.

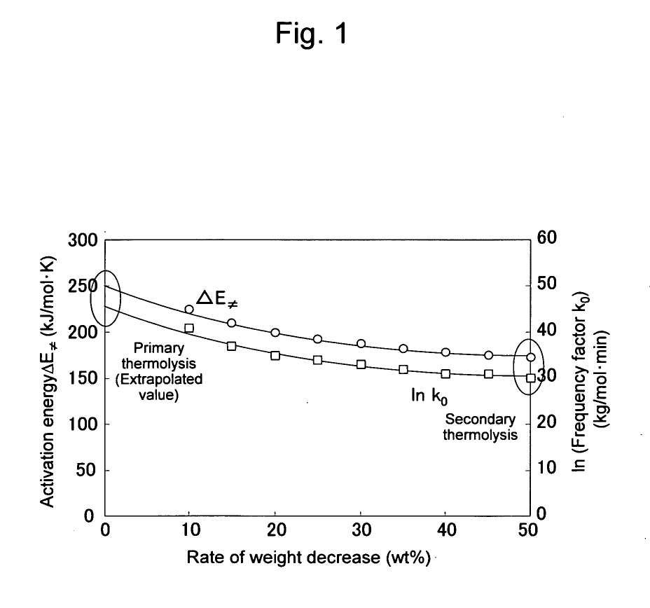

FIG. 2 is a graph showing the Arrhenius plot for an esterification reaction as obtained from an experiment.

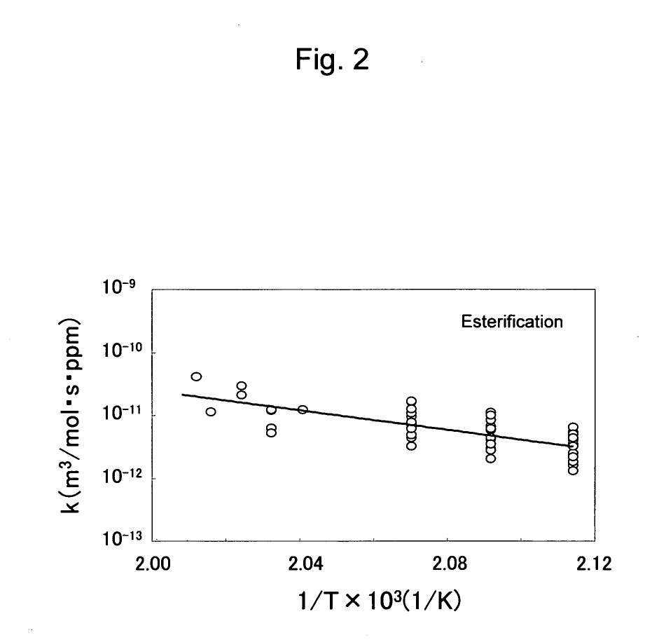

FIG. 3 is a graph showing the Arrhenius plot for a polycondensation reaction as obtained from an experiment.

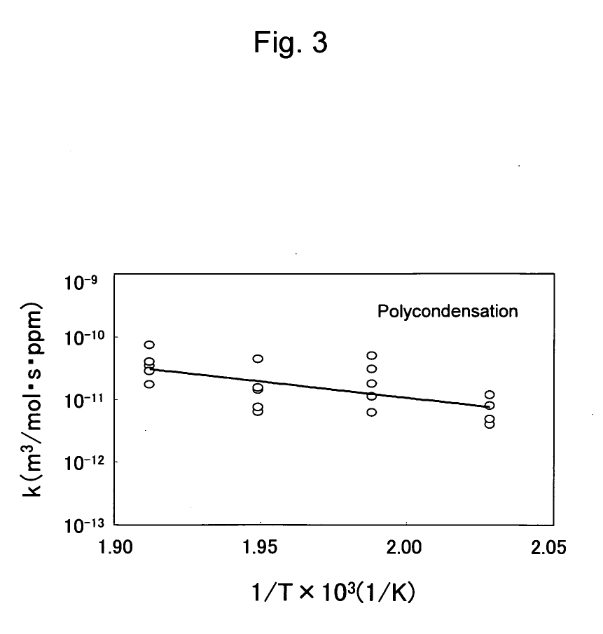

FIG. 4 is a diagram for explaining the production apparatus for PTT of the present invention.

FIG. 5 is a diagram for explaining a horizontal twin-shaft polymerization vessel to be used in the final stage of the polycondensation step according to the production method for PTT of the present invention.

### DETAILED DESCRIPTION OF THE PREFERRED EMBODIMENTS

The present invention is described in detail as follows.

A continuous polymerization plant for PTT (and upon normal operation, such polymerization plant performs simultaneous and continuous supply of raw materials and discharge of a reaction solution), which is an object of the present invention, at least has an esterification step and a polycondensation step substantially composed by serially connecting a plurality of polymerization vessels. An object of the esterification step is to generate oligomers having hydroxy groups at their ends by causing ester binding of the terminal carboxyl group of PTA to a hydroxy group of PDO via heating in the presence of a catalyst. At this time, the average degree of polymerization of oligomers is not always required to be 1. In order to avoid a loss of the reactivity of a raw material due to a cyclization reaction within oligomer molecules, for example, a target average degree of polymerization is selected and then a raw material may be mixed at a PTA/PDO molar ratio suitable for such degree.

The polycondensation step for polymerization of the thus obtained oligomers is generally divided into 2 to 3 stages according to the degree of vacuum. At this time, the later in the subsequent stage, the higher the degree of vacuum that is set for a polymerization vessel. This is because the amount of byproduct PDO to be generated in association with the advancement of a polycondensation reaction and degassed and the concentration of the byproduct PDO in molten prepolymers gradually decrease. One factor governing PDO degassing is partial pressure. When the concentration of PDO is low, partial pressure is proportional to the concentration of PDO in a non-volatile molten polymer, following Henry's law. A requirement for dissolved PDO in molten polymer to generate air bubbles is that partial pressure of PDO must be higher than the sum of water head (due to the molten polymers' own weight, which acts on the location) and the pressure of the atmosphere (operational pressure). When PDO concentration decreases in the subsequent stage of the polycondensation step, neither degassing of PDO nor a polycondensation reaction will proceed, unless operational pressure is decreased to prepare an environment with a high degree of vacuum in order to compensate for the resulting decrease in partial pressure. Also, degassing of PDO takes place mainly at the interface between the molten prepolymer and the external space thereof. Dissolved PDO is diffused and transferred from a bulk layer of the molten prepolymer to the interface by the effect of surface renewal associated with agitation, facilitating degassing. At this time, agitation effects are lowered as viscosity increases. Hence, it is important to select process conditions and equipment in anticipation of such lowered effects.

With the progress of a polycondensation reaction, the molecular weight of the molten prepolymer is increased, and viscosity also increases. In polycondensation of a polyester (analogous thereto) such as polyethylene terephthalate (PET) or polybutylene terephthalate (PBT), generally the polymerization temperature is increased in accordance with the degree of vacuum as the polycondensation reaction proceeds. This is performed to compensate for a decrease in the reaction amount itself due to decreased concentration of reactive terminal groups, through an increased reaction rate in association with a temperature rise, elevated partial pressure of glycol as a byproduct, and an improved effect of surface renewal due to decreased viscosity. For regions with high viscosity, for which the reaction is not accelerated despite such efforts, a polymerization vessel for high viscosity having a twin-shaft agitator capable of mixing even fluids with high viscosity is used in the subsequent stage of the polycondensation step. However, in the case of PTT, unlike PET or PBT, sensitivity to a thermolysis reaction is extremely high, so that the polymerization temperature cannot be increased as the reaction proceeds as described above. With the use of 250° C. as the upper limit if possible, it is desired to gradually lower the polymerization temperature as the reaction proceeds during the subsequent stage. At least in the final-stage polymerization, where the number of ester bonds per molecule is large because of a higher molecular weight and higher sensitivity to thermolysis, the temperature is required to be less than 250° C. Accordingly, in the case of PTT, a polycondensation process using a polymerization vessel for high viscosity is constructed at an earlier stage in the polycondensation step than in the cases of other polyesters, and thus decreases in partial pressure of PDO and reaction rate are compensated for by improvement in surface renewability. In this manner, the polymerization reaction should be accelerated. Specifically, the polymerization time during the final stage of the polycondensation step is preferably set to be 0.5 to 3.0 times, and desirably 0.9 to 1.5 times, the total polymerization time during the former stage of the polycondensation step.

The polycondensation step is generally divided into 3 stages: initial polymerization, intermediate polymerization, and final polymerization using a polymerization vessel for high viscosity. Alternatively, it is often divided into 2 stages: initial polymerization and final polymerization. At this time, a tank-type agitator is generally used for a polymerization vessel for initial polymerization. The degree of vacuum during initial polymerization upon PTT production preferably ranges from 5 to 100 torr and particularly preferably ranges from 10 to 20 torr. If an excessively high degree of vacuum is established, degassing of PDO proceeds rapidly and PDO can be removed from the system to a greater extent than necessary. In this case, chances of esterification of some carboxyl terminal groups generated by reaction equilibrium are reduced, and such reduction is undesirable in view of the quality of the final polymer, such as in terms of acid value. Also, the polymerization time in initial polymerization is preferably set so that it accounts for 10% to 40%, and particularly preferably accounts for 20% to 30%, of the total polymerization time of the polycondensation step.

As a polymerization vessel for intermediate polymerization, in general, a polymerization vessel having a horizontal single-shaft agitator is often used. The polymerization vessel having a disc-type agitation blade performs mixing while increasing evaporation surface area through liquid film formation and the effect of surface renewal upon lifting up of a reaction solution with the use of the agitation blade followed by the gravitational fall of the reaction solution. In this manner, the degassing of byproducts is accelerated. When a reaction solution with low viscosity is handled, generally, a gate is equipped within a reaction tank of a polymerization vessel so as to improve plug flowability. Also, when a reaction solution with nearly high viscosity is handled, durable viscosity is often set at a higher level through adjustment of the shape of the agitation blade or the method for installing the same. In the case of a polymer that does not always have high viscosity, final polymerization using a polymerization vessel for high viscosity can be omitted. However, when the polymerization time in intermediate polymerization may be relatively short, as in the case of PTT production, a tank-type polymerization vessel may also be used instead of a horizontal polymerization vessel. The degree of vacuum for intermediate polymerization upon PTT production preferably ranges from 1 to 20 torr and particularly preferably ranges from 2 to 5 torr. Also, the polymerization time for intermediate polymerization is preferably set to account for 10% to 40%, and particularly preferably 20% to 30%, of the total polymerization time of the polycondensation step.

In the present invention, since final viscosity approaches or exceeds 1 kPa·s, polycondensation is performed using a polymerization vessel having a twin-shaft agitator in the final stage of the polycondensation step. A horizontal polymerization vessel for high viscosity having such a twin-shaft agitator to be used for final polymerization is generally operated in a manner such that agitation shafts rotate in the opposite directions from each other, and thus a molten polymer lifted up by the agitation blades is extended. Therefore, the area of degassing interface is increased and mixing of a solution with high viscosity proceeds with the effects of repeated extending and folding. At this time, an agitation blade provided on each agitation shaft comes into contact with the molten polymer adhering to the other agitation shaft and then peel off the polymer, thereby suppressing excessive residence of the molten polymer within the polymerization vessel and the progress of thermolysis associated therewith. The degree of vacuum of final polymerization upon PTT production is preferably 2 torr or less and is particularly preferably 1 torr or less. In addition, a typical example of such a polymerization vessel having a twin-shaft agitator is a horizontal spectacle blade polymerization vessel as disclosed in JP Patent Publication (Kokoku) No. 06-021159 B (1994).

Next, an embodiment of the production apparatus of the present invention is provided as described below, but the scope of the present invention is not limited thereto.

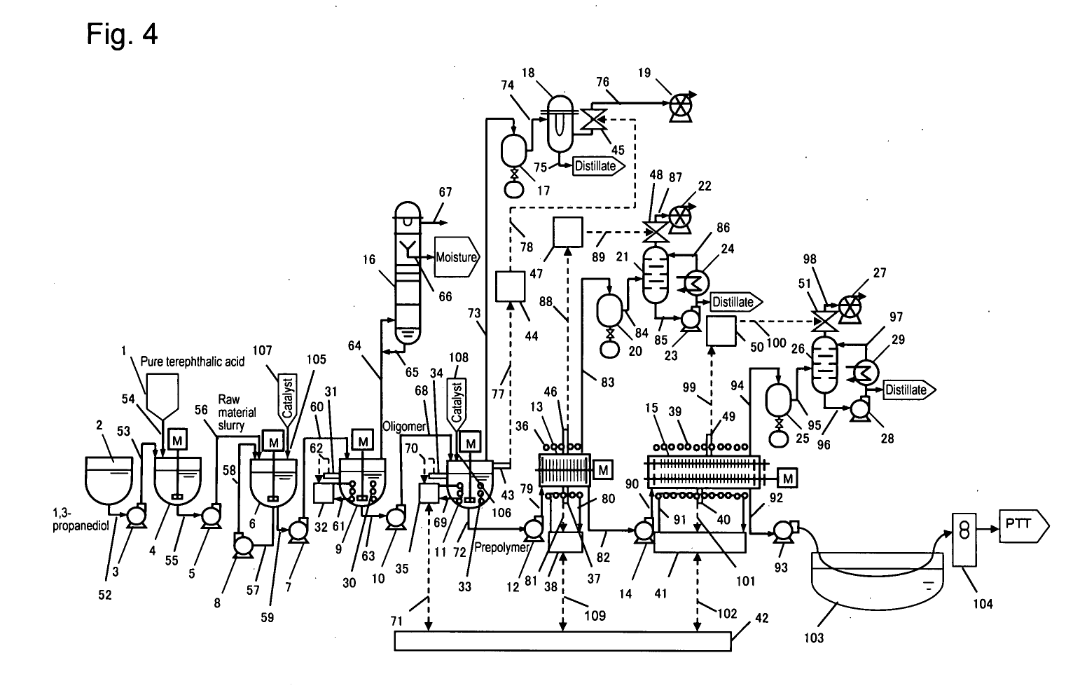

FIG. 4 shows an embodiment of the production apparatus (production plant) for PTT of the present invention. The production apparatus contains, as major forms of equipment, an esterification bath 9, an initial polymerization vessel 11, an intermediate polymerization vessel 13, and a final polymerization vessel 15.

First, PTA is supplied from a PTA supply tank 1 to a raw-material blending tank 4 via a pipe 54. Since PTA is powder, the PTA supply tank 1 is desirably equipped with a screw feeder or the like as a means for supplying the powder at an outlet, so as to control the supply rate. Also, PDO is supplied from a PDO supply tank 2 to the raw-material blending tank 4 by a solution delivery pump 3 via pipes 52 and 53 at a predetermined flow rate. PDO is a liquid having a very low viscosity of about 0.1 Pa·s. Hence, as the solution delivery pump 3, various pumps such as canned pumps and plunger pumps are applicable. The supply rate for PTA and PDO is determined so that the PDO/PTA (both raw materials) molar ratio within the raw-material blending tank 4 is as predetermined. The PDO/PTA molar ratio generally ranges from 1 (1:1) to 2.5 (2.5:1) and desirably ranges from 1.3 (1.3:1) to 2.0 (2.0:1). This is in order to suppress the generation of non-polymerizable cyclic oligomers, and particularly trimers, in the subsequent stage of the esterification step.

In the raw-material blending tank 4, PDO and PTA are mixed and slurried. Then the slurry is supplied by a solution delivery pump 5 to a slurry supply tank 6 via pipes 55 and 56. In the slurry supply tank 6, while the supplied slurry and a catalyst to be supplied from a catalyst supply tank 107 via a pipe 105 are mixed, the mixture of the slurry and the catalyst (hereinafter, also referred to as a slurry) is circulated via pipes 57 and 58 by a solution delivery pump 8. The slurry is continuously discharged to the esterification bath 9 by a solution delivery pump 7 via pipes 59 and 60. As the solution delivery pumps 5, 7, and 8, various pumps such as canned pumps and plunger pumps are applicable, similarly to the case of solution delivery pump 3. As catalysts to be supplied, 2 types of catalyst (a solid catalyst and a liquid catalyst) are applicable. In the case of a solid catalyst, powder of an oxide such as titanium, germanium, or antimony is often used, and titanium dioxide is particularly preferably used in view of reactivity. When a solid catalyst is used, the catalyst supply tank 107 is desirably equipped with a screw feeder or the like as a means for supplying the solid catalyst at the tank outlet, so as to control the supply rate.

Meanwhile, in the case of a liquid catalyst, an organic metal such as titanium, aluminum, or zinc is often used, and titanium tetrabutoxide is particularly preferably used in view of reactivity. When a liquid catalyst is used, the catalyst supply tank 107 is desirably equipped with a quantitative solution delivery pump as a means for supplying the liquid catalyst at the tank outlet, so as to control the supply rate. The amount of a catalyst to be added preferably ranges from 100 ppm to 1000 ppm, and it particularly preferably ranges from 300 ppm to 500 ppm, in terms of titanium atoms with respect to the slurry. The above Patent document 3 suggests that titanium dioxide is less affected by thermal degradation reaction of PDO represented by formula 3 than titanium tetrabutoxide. However, basically both a solid catalyst and a liquid catalyst are applicable. Slurry circulation by the solution delivery pump 8 is performed to suppress the solid-liquid separation that mainly takes place in the slurry, but can be omitted as necessary. Also, as necessary, the raw-material blending tank 4, the pipes 55 and 56, and the solution delivery pump 5 can be omitted and PDO and PTA can be directly supplied to the slurry supply tank 6. In such a case, the slurry supply tank 6 has the additional function of slurrying PDO/PTA.

A slurry is heated to a predetermined temperature by a heating means 30 while being agitated and mixed in the esterification bath 9 under an inert atmosphere of nitrogen or the like. As the esterification bath 9, a tank-type agitation tank is desired. Accordingly, an esterification reaction of formula 1 takes place, a generated byproduct (that is, water) is vaporized in a slurry solution to form air bubbles and then degassed. Degassed water vapor is delivered partially together with PDO or volatile low-molecular-weight oligomers via a pipe 64 to a reflux column 16. In the reflux column 16, separation takes place due to a difference in condensation temperature, and PDO or oligomers having a high boiling point are condensed and then returned to the esterification bath 9 via the pipes 65 and 64. Components having low boiling points, mainly composed of water vapor, are discharged from the system via a pipe 66. Exhaust gas is then generally condensed, subjected to waste water treatment such as biological treatment, and then released from the system. Gas components remaining after removal thereof are discharged from the system via a pipe 67. As the heating means 30, various methods are applicable, such as heating with the use of a heat exchanger or a heater installed within or outside the tank, and heating by combined use thereof. In a commercial plant, an internal heat exchanger is often used. A heating medium heated to a predetermined temperature by a heat medium heater 32 is delivered to the heating means 30 via a pipe 61 and then circulated. The heat medium heater 32 should have a function of setting and controlling the temperature of a heating medium. The esterification bath 9 is equipped with a temperature measuring instrument 31 for monitoring the temperature of slurries and transmitting the results to the heat medium heater 32 via a cable 62. In the heat medium heater 32, in response to the results, the temperature of the heating medium is controlled so that the slurry is at the predetermined temperature. Molten oligomers (hereinafter, simply referred to as oligomers) generated by the reaction of formula 1 in the esterification bath 9 are delivered by a solution delivery pump 10 to the initial polymerization vessel 11 via pipes 63 and 68. Oligomers are not slurries, but liquids, so that there is no concern about solid-liquid separation. Note that, in the esterification bath 9, the supply of slurries from the pipe 60 and the discharge of oligomers from the pipe 63 are continuously performed. Process conditions in the esterification bath 9 are as follows. The pressure ranges from 0.5 to 2.0 atmospheric pressure and desirably ranges from 0.9 to 1.1 atmospheric pressure. The temperature ranges from 180° C. to 250° C. and desirably ranges from 200° C. to 230° C. The residence time of slurries ranges from 1 to 5 hours and desirably ranges from 2.5 to 4 hours. The pipes 63 and 68, as well as the solution delivery pump 10, are also heated to and kept at almost the same temperature as that within the esterification bath 9, so as to suppress the solidification of oligomers. As the solution delivery pump 10, similarly to the case of the solution delivery pumps 3 and 8, various pumps such as gear pumps to be used for liquids with higher viscosity are applicable, in addition to canned pumps, plunger pumps, and the like.

In the initial polymerization vessel 11, oligomers are heated to a predetermined temperature by a heating means 33 while being agitated and mixed with a catalyst to be supplied from a catalyst supply tank 108 via a pipe 106 under an inert and reduced pressure atmosphere (created using a decompressor 19). As the initial polymerization vessel 11, a tank-type agitation tank is desired. In addition, when a catalyst in the esterification step remains unaffected (e.g., not inactivated) and can sufficiently act also in a polycondensation reaction, additional addition of the catalyst is not always required and can be omitted. Therefore, the polycondensation reaction of formula 2 takes place, the thus generated byproduct; that is, PDO is vaporized in oligomers to form air bubbles and is then degassed. As a catalyst to be supplied, 2 types of catalyst (a solid catalyst and a liquid catalyst) are applicable and a liquid catalyst is desired in view of reactivity. In the case of a solid catalyst, powder of an oxide such as titanium, germanium, or antimony is often used, and particularly antimony oxide is desired in view of reactivity. When a solid catalyst is used, the catalyst supply tank 108 is desirably equipped with a screw feeder or the like as a means for supplying the solid catalyst at the tank outlet, so as to control the supply rate.

Meanwhile, in the case of a liquid catalyst, organic metal such as titanium, aluminum, or zinc is often used and particularly titanium tetrabutoxide is desired in view of reactivity. When a liquid catalyst is used, the catalyst supply tank 108 is desirably equipped with a quantitative solution delivery pump as a means for supplying the liquid catalyst at the tank outlet, so as to control the supply rate. The amount of a catalyst to be added preferably ranges from 100 ppm to 1000 ppm and particularly preferably ranges from 300 ppm to 600 ppm in terms of titanium atoms with respect to the slurry. Degassed PDO is delivered together with volatile low-molecular-weight oligomers to a cold trap 17 via a pipe 73. In the cold trap 17, low-molecular-weight oligomers are converted into a condensate and separated from the vapor phase using a difference in condensation temperature. PDO vapor having a high boiling point is delivered to a condenser 18 via a pipe 74. The condenser 18 may be a general indirect heat exchange capacitor or a wet capacitor, and the former example is preferably used.

At a stage when a predetermined amount of the liquefied low-molecular-weight oligomers is accumulated, the oligomers are discharged from the system or returned to the upstream side such as the esterification bath for reuse as a part of raw materials. In the condenser 18, PDO is converted into a condensate and thus separated from the vapor phase and the remaining gas components are discharged via a pipe 76 and the decompressor 19. At a stage when the predetermined amount of liquefied PDO is accumulated, the liquefied PDO is discharged from the system or returned to the upstream side such as the esterification bath for reuse as a part of raw materials. Exhaust gas is then desirably condensed, subjected to waste water treatment such as biological treatment, and then released from the system. As the decompressor 19, any of a vacuum pump, an ejector to be operated by a fluid, and the like is applicable. As the heating means 33, various methods are applicable such as heating with the use of a heat exchanger or a heater to be installed within or outside the tank and heating by a combined use thereof. In a commercial plant, an internal heat exchanger is often used. A heating medium heated to a predetermined temperature by a heat medium heater 35 is delivered to the heating means 33 via a pipe 69 for circulation. The heat medium heater 35 should have a function of measuring and controlling the temperature of a heating medium. The initial polymerization vessel 11 is equipped with a temperature measuring instrument 34 for monitoring the temperature of oligomers and transmitting the result to the heat medium heater 35 via a cable 70. In the heat medium heater 35, in response to the result, the temperature of the heating medium is controlled so that oligomers are at the predetermined temperature. Prepolymers generated by the reaction of formula 2 in the initial polymerization vessel 11 are delivered by a solution delivery pump 12 to the intermediate polymerization vessel 13 via pipes 72 and 79.

Note that, at the initial polymerization vessel 11, the supply of oligomers from the pipe 68 and the discharge of prepolymers from the pipe 72 are continuously performed. Process conditions in the initial polymerization vessel 11 are as follows. The degree of vacuum ranges from 5 torr to 100 torr and desirably ranges from 10 torr to 20 torr. When the degree of vacuum is set at en excessively high level, PDO degassing proceeds rapidly and PDO may be removed from the system and transferred to the outside of the system to a greater extent than necessary. In this case, chances of esterification of some carboxyl terminal groups generated by reaction equilibrium are reduced, and such reduction is undesirable in view of the quality of the final polymer such as in terms of acid value. To control the degree of vacuum at a predetermined value, the initial polymerization vessel 11 is equipped with a vacuum gauge 43. The thus measured degree of vacuum is transmitted to a control apparatus 44 via a cable 77. The control apparatus 44 controls the degree of vacuum by regulating the opening degree of a valve 45 via a cable 78 in response to the transmitted degree of vacuum. Also, the residence time of oligomers in the initial polymerization vessel 11; that is, the polymerization time for initial polymerization is set so that it ranges from 1 to 4 hours and desirably ranges from 2 to 3 hours. The polymerization temperature for oligomers is set so that it ranges from 180° C. to 250° C. and desirably ranges from 240° C. to 250° C. The pipes 72 and 79, and the solution delivery pump 12 are heated to and kept at almost the same temperature as that within the initial polymerization vessel 11, so as to suppress the solidification of oligomers. As the solution delivery pump 12, similarly to the case of the solution delivery pumps 3, 8, and 10, various pumps including canned pumps, plunger pumps, and gear pumps are applicable. Through initial polymerization, prepolymers having the number average degree of polymerization ranging from about 20 to 30 are generated.

Subsequently, in the intermediate polymerization vessel 13, prepolymers are heated to a predetermined temperature by a heating means 36 while being agitated and mixed under an inert and reduced pressure atmosphere (created using a decompressor 22). Therefore, the polycondensation reaction of formula 2 is further accelerated, the thus generated byproduct; that is, PDO, is vaporized in prepolymers to form air bubbles and then degassed. Degassed PDO is delivered together with volatile low-molecular-weight oligomers to a cold trap 20 via a pipe 83. In the cold trap 20, low-molecular-weight oligomers are converted into a condensate and separated from the vapor phase using a difference in condensation temperature. PDO vapor having a high boiling point is delivered to a condenser 21 via a pipe 84.

At a stage when the predetermined amount of liquefied low-molecular-weight oligomers is accumulated, the oligomers are discharged from the system or returned to the upstream side such as the esterification bath for reuse as a part of raw materials. The condenser 21 may be a general indirect heat exchange capacitor or a wet capacitor and the latter is preferably used. A refrigerant accumulated in the bottom part of the condenser 21 is delivered by a solution delivery pump 24 to the top part of the condenser 21 via pipes 85 and 86 and then sprayed to the interior of the condenser 21. Gas delivered from the pipe 84 comes into contact with the refrigerant sprayed within the condenser 21 and thus is cooled. PDO is condensed and reaches the bottom part of the condenser 21.

At a stage when the predetermined amount of a PDO condensate (distillate) is accumulated, the PDO condensate is discharged from the system or returned to the upstream side such as the esterification bath for reuse as a part of raw materials. In the condenser 21, PDO is converted into a condensate and separated from the vapor phase. The remaining gas components are discharged via a pipe 87 and the decompressor 22. Exhaust gas is then desirably condensed, subjected to waste water treatment such as biological treatment, and then released from the system. As the decompressor 22, any of a vacuum pump, an ejector to be operated by a fluid, and the like is applicable. As the heating means 36, various methods are applicable such as heating with the use of a heat exchanger or a heater to be installed within or outside the tank and heating by a combined use thereof. In a commercial plant, an external heat exchanger (heating medium jacket) is often used. A heating medium heated to a predetermined temperature by a heat medium heater 38 is delivered to the heating means 36 via a pipe 80 for circulation. The heat medium heater 38 should have a function of measuring and controlling the temperature of a heating medium. The intermediate polymerization vessel 13 is equipped with a temperature measuring instrument 37 for monitoring the temperature of prepolymers and transmitting the result to the heat medium heater 38 via a cable 81. In the heat medium heater 38, in response to the result, the temperature of the heating medium is controlled so that prepolymers are at the predetermined temperature. Prepolymers grown by the reaction of formula 2 in the intermediate polymerization vessel 13 are delivered by a solution delivery pump 14 to the final polymerization vessel 15 via pipes 82 and 90.

Note that, in the intermediate polymerization vessel 13, the supply of prepolymers from the pipe 79 and the discharge of prepolymers from the pipe 82 are continuously performed. Process conditions in the intermediate polymerization vessel 13 are as follows. The degree of vacuum ranges from 1 torr to 20 torr and desirably ranges from 2 torr to 5 ton. The intermediate polymerization vessel 13 is equipped with a vacuum gauge 46 for controlling the degree of vacuum at a predetermined value. The measured degree of vacuum is transmitted to a control apparatus 47 via a cable 88. In the control apparatus 47, the opening degree of a valve 48 is regulated via a cable 89 in response to the transmitted degree of vacuum, so as to control the degree of vacuum. Also, the residence time of prepolymers in the intermediate polymerization vessel 13; that is, the polymerization time in intermediate polymerization ranges from 1 to 4 hours and desirably ranges from 2 to 3 hours. The polymerization temperature for prepolymers is set at a temperature ranging from 230° C. to 250° C. and desirably ranging from 240° C. to 250° C. The pipes 82 and 90, and the solution delivery pump 14 are also heated to and kept at almost the same temperature as that within the intermediate polymerization vessel 13, so as to suppress the solidification of prepolymers. For the solution delivery pump 14, a gear pump compatible with a fluid with high viscosity is desirably applied.

In addition, in an example in FIG. 4, a horizontal polymerization vessel is employed as the intermediate polymerization vessel, but the present invention is not restricted to such an example. When the residence time of oligomers is short, a tank-type agitator (used as the initial polymerization vessel 11) may also be used as the intermediate polymerization vessel. Through intermediate polymerization, prepolymers having the number average degree of polymerization ranging from about 40 to 60 are generated.

Next, in the final polymerization vessel 15, prepolymers are heated to a predetermined temperature by a heating means 39 while being agitated and mixed under an inert and reduced pressure atmosphere (created using a decompressor 27). Therefore, the polycondensation reaction of formula 2 is further accelerated, the thus generated byproduct; that is, PDO, is vaporized in prepolymers to form air bubbles and then degassed. Degassed PDO is delivered together with volatile low-molecular-weight oligomers to a cold trap 25 via a pipe 94. In the cold trap 25, low-molecular-weight oligomers are converted into a condensate and separated from the vapor phase using a difference in condensation temperature. PDO vapor having a high boiling point is delivered to a condenser 26 via a pipe 95.

At a stage when the predetermined amount of liquefied low-molecular-weight oligomers is accumulated, the liquefied low-molecular-weight oligomers are discharged from the system or returned to the upstream side such as the esterification bath for reuse as a part of raw materials. The condenser 26 may be a general indirect heat exchange capacitor or a wet capacitor and the latter is preferably used. A refrigerant accumulated in the bottom part of the condenser 26 is delivered by a solution delivery pump 29 to the top part of the condenser 26 via pipes 96 and 97 and then sprayed to the interior of the condenser 26. Gas delivered from the pipe 95 comes into contact with the refrigerant sprayed within the condenser 26 and thus is cooled. PDO is condensed and reaches the bottom part of the condenser 26.

At a stage when the predetermined amount of a PDO condensate (distillate) is accumulated, the PDO condensate is discharged from the system or returned to the upstream side such as the esterification bath for reuse as a part of raw materials. In the condenser 26, PDO is converted into a condensate and separated from the vapor phase. The remaining gas components are discharged via a pipe 98 and a decompressor 27. Exhaust gas is then desirably condensed, subjected to waste water treatment such as biological treatment, and then released from the system. As the decompressor 27, any of a vacuum pump, an ejector to be operated by a fluid, and the like is applicable. As the heating means 39, various methods are applicable such as heating with the use of a heat exchanger or a heater to be installed within or outside the tank and heating by a combined use thereof. In a commercial plant, an external heat exchanger (heating medium jacket) is often used. A heating medium heated to a predetermined temperature by a heat medium heater 41 is delivered to the heating means 39 via a pipe 91 for circulation. The heat medium heater 41 should have a function of measuring and controlling the temperature of a heating medium. The final polymerization vessel 15 is equipped with a temperature measuring instrument 40 for monitoring the temperature of prepolymers and transmitting the result to the heat medium heater 41 via a cable 101. In the heat medium heater 41, in response to the result, the temperature of the heating medium is controlled so that prepolymers are at the predetermined temperature. Prepolymers grown by the reaction of formula 2 in the final polymerization vessel 15 are delivered by a solution delivery pump 93 to a polymer strand cooling bath 103 via a pipe 92.

Note that, in the final polymerization vessel 15, the supply of prepolymers from the pipe 90 and the discharge of polymers from the pipe 92 are continuously performed. Process conditions in the final polymerization vessel 15 are as follows. The degree of vacuum is 2 torr or less and desirably 1 torr or less. The final polymerization vessel 15 is equipped with a vacuum gauge 49 for controlling the degree of vacuum at a predetermined value. The thus measured degree of vacuum is transmitted to a control apparatus 50 via a cable 99. In the control apparatus 50, the opening degree of a valve 51 is regulated via a cable 100 in response to the transmitted degree of vacuum, so as to control the degree of vacuum.

Also, the residence time of prepolymers in the final polymerization vessel 15; that is, the polymerization time in final polymerization is set so that it ranges from 4 to 8 hours and it desirably ranges from 5 to 6 hours. The polymerization temperature for prepolymers is set at a temperature ranging from 230° C. to 250° C. and desirably ranging from 240° C. to 250° C. The pipe 92 and the solution delivery pump 93 are also heated to and kept at almost the same temperature as that within the final polymerization vessel 15, so as to suppress the solidification of prepolymers. For the solution delivery pump 93, a gear pump compatible with a fluid with high viscosity is desirably applied. Through final polymerization, polymers having the number average degree of polymerization ranging from about 80 to 110 are generated.

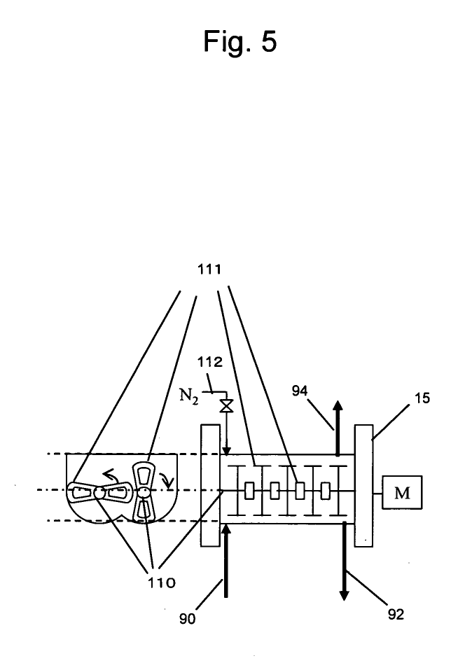

Since the viscosity of prepolymers is high in the final polymerization vessel 15, a polymerization vessel having a twin-shaft agitator compatible with such high viscosity should be used. A typical example of such a twin-shaft agitator is a horizontal spectacle blade polymerization vessel (Hitachi Plant Technologies, Ltd.). FIG. 5 shows the outline of a spectacle blade polymerization vessel. Within the polymerization vessel, the internal vapor phase is substituted once with inert gas via a pipe 112 and then the resultant is discharged via a pipe 94 for decompression. Within the polymerization vessel, two agitation shafts 110 are installed horizontally with regard to the ground and parallel to each other and each agitation shaft is equipped with a predetermined number of agitation blades 111. Agitation blades adjacent to each other between two agitation shafts installed parallel to each other are installed, so that the phase angles thereof are shifted by 90° relative to each other. Also, agitation blades are installed on the same agitation shaft while shifting the phase angles by 90° at a time. Two agitation shafts 110 rotate in opposite directions from each other. A viscous fluid is lifted up at the central portion of a cross section of the polymerization vessel, and it is then extended using agitation blades. The thus extended viscous fluid is caused to fall by gravity onto a fluid residence part at the lower portion within the polymerization vessel. Through extension, the area of fluid interface is increased and the thickness of liquid film is decreased. These effects accelerate the diffusion and transfer of substances from the fluid bulk layer to the interface. Also, gravitational falling and the following agitation and mixing by the agitation blades 111 in the fluid residence part at the lower portion within the polymerization vessel have the effect of folding the extended fluid, thereby achieving uniform diffusion of the fluid following agitation and mixing. Such effects of increased area of fluid interface, surface renewal, and diffusion and mixing cause byproduct PDO generated by a polycondensation reaction represented by formula 3 to be transferred from the bulk layer of prepolymers to the interface layer, to be evaporated at the interface, and then to be degassed by air bubble formation, so that a polycondensation reaction is accelerated.

In addition, the control apparatuses 35, 38, and 41 are connected to a polycondensation process control apparatus 42 via cables 71, 109, and 102. In the polycondensation process control apparatus 42, the set value for each temperature is input so as to satisfy: (the temperature of oligomers within the initial polymerization vessel 11)>(the temperature of prepolymers within the intermediate polymerization vessel 13)>(the temperature of prepolymers within the final polymerization vessel 15). The set value is transmitted to the control apparatuses 35, 38, and 41 and the control apparatuses 35, 38, and 41 transmit the temperature of oligomers within the initial polymerization vessel 11, the temperature of prepolymers within the intermediate polymerization vessel 13, and the temperature of prepolymers within the final polymerization vessel 15, so that the operation condition can be confirmed. The above conditions concerning the temperature of prepolymers (oligomers) are satisfied, making it possible to suppress thermolysis in PTT polymerization, and particularly at the final phase.

In addition, the polymerization temperature for all stages of the polycondensation step is preferably 250° C. or lower. Subject to satisfaction of the above requirements (conditions) concerning the temperature of prepolymers (oligomers) for each polymerization vessel, the temperature during a stage (e.g., the temperature of oligomers within the initial polymerization vessel 11) may be higher than 250° C., if necessary. Also, the liquid level of each reaction solution in the initial polymerization vessel 11, the intermediate polymerization vessel 13, or the final polymerization vessel 15 is generally monitored using a liquid level meter such as a dielectric and a radiotransparent liquid level meter. Such a liquid level meter is installed at a position so that it is not easily affected by an agitator, such as a position near an outlet for a reaction solution, and is capable of monitoring the height in the vertical direction. The residence amount of a reaction solution is evaluated using the liquid level meter so as to confirm ratios among the polymerization time in the initial polymerization vessel 11, the same in the intermediate polymerization vessel 13, and the same in the final polymerization vessel 15, in the polycondensation step. In the case of PTT, the liquid level is desirably regulated so that: the polymerization time in the final stage of the polycondensation step is 0.5 to 3.0 times and desirably 0.9 to 1.5 times the total polymerization time in the previous stages of the polycondensation step; that is, the volume of molten polymers charged (the volume occupied by a reaction solution part when agitation is stopped and the reaction solution is left to stand within a polymerization vessel) in the polymerization vessel in the final stage is 0.5 to 3.0 times and desirably 0.9 to 1.5 times the total volume of the molten polymers charged in the polymerization vessel in the previous stages. Therefore, the effect of surface renewal can be optimized and a polycondensation reaction can be appropriately proceeded. Liquid level can be generally regulated by changing differential pressure through adjustment of the opening degree of a valve provided at an outlet pipe (pipe 72, 82, or 92). Even in this case, the liquid level cannot be set at a level lower than the minimum liquid level when the opening degree of the valve is set at the maximum degree.

Polymers discharged from the solution delivery pump 93 are cooled with water by the polymer strand cooling bath 103 and then pelleted by a chip cutter 104, so that polymer products can be produced.

Next, the present invention will be described in more detail below with reference to an example. However, the present invention is not limited to the example.

### Example 1

PTT was polymerized by the following procedures using production apparatuses shown in FIGS. 4 and 5.

First, in a raw-material blending tank 4, these raw materials were mixed at a PDO/PTA molar ratio of 2.0 (2.0:1) and then the mixture was supplied to a slurry supply tank 6. In the slurry supply tank 6, titanium tetrabutoxide was added as a catalyst at 423 ppm in terms of titanium atoms and then mixed. The resultant was then delivered to an esterification bath 9. In the esterification bath 9, esterification was performed under conditions of 0.9 to 1.1 atmospheric pressure, a temperature of 210° C., and the slurry residence time of 3 hours. As a result, oligomers with an esterification rate of 96.2% were obtained. The thus obtained oligomers were supplied to an initial polymerization vessel 11. In the initial polymerization vessel 11, titanium tetrabutoxide was additionally added as a catalyst at 565 ppm in terms of titanium atoms. Polymerization was performed under conditions of the degree of vacuum of 20 torr, a temperature of 250° C., and the oligomer residence time of 2 hours. The thus generated prepolymers were supplied to an intermediate polymerization vessel 13. In the intermediate polymerization vessel 13, polymerization was performed under conditions of the degree of vacuum of 3 torr, a temperature of 249° C., and the oligomer residence time of 3 hours. As a result, prepolymers having a number average molecular weight of 11,000 and an acid value of 14 eq/t were obtained. The thus obtained prepolymers were supplied to a final polymerization vessel 15. In the final polymerization vessel 15, polymerization was performed under conditions of the degree of vacuum of 1 torr, a temperature of 248° C., and the prepolymer residence time of 5 hours. In addition, as a final polymerization vessel, a horizontal twin-shaft spectacle blade polymerization vessel was applied. The thus obtained PTT polymers were cooled in a polymer strand cooling bath 103, pelleted by a chip cutter 104, and then subjected to various analyses. As a result, it was confirmed that PTT polymers having a number average molecular weight of 21,000 and an acid value of 24 eq/t were obtained. It was confirmed that PTT polymers obtained in this Example were polymers categorized as those having low acid values, compared with polymers (acid value ranging from 25 to 35 eq/t) that are generally available for purchase.

### DESCRIPTION OF SYMBOLS

1 PTA supply tank
2 PDO supply tank
3, 5, 7, 8, 10, 12, 14, 24, 93 Solution delivery pump
4 Raw-material blending tank
6 Slurry supply tank
9 Esterification bath
11 Initial polymerization vessel
13 Intermediate polymerization vessel
15 Final polymerization vessel
16 Reflux column
17, 20, 25 Cold trap
18, 21, 26 Condenser
19, 22, 27 Decompressor
30, 33, 36, 39 Heating means
31, 34, 37, 40 Temperature measuring instrument
32, 35, 38, 41, 44, 47, 50 Heat medium heater
43, 46, 49 Vacuum gauge
45, 48, 51 Valve
52-61, 63-69, 72-74, 76, 79-80, 82-87, 90-92, 94-98, 105-106, 112 Pipe
62, 70-71, 77-78, 81, 88-89, 99-102, 109 Cable
103 Polymer strand cooling bath
104 Chip cutter
107, 108 Catalyst supply tank
110 Agitation shaft
111 Agitation blade

What is claimed is:

1. A production method for polytrimethylene terephthalate comprising an esterification step and a polycondensation step, wherein:
the polycondensation step is divided into multiple stages; polycondensation is performed with a polymerization vessel having a twin-shaft agitator during the final stage of the polycondensation step; and the polymerization temperature during the subsequent stage of the polycondensation step is lower than the polymerization temperature during the former stage of the polycondensation step.

2. The production method for polytrimethylene terephthalate according to claim 1, wherein the polymerization temperature during the final stage of the polycondensation step is 250° C. or lower.

3. The production method for polytrimethylene terephthalate according to claim 1, wherein the polymerization time during the final stage of the polycondensation step is 0.5 to 3.0 times the total polymerization time during the former stages of the polycondensation step.

4. The production method for polytrimethylene terephthalate according to claim 2, wherein the polymerization time during the final stage of the polycondensation step is 0.5 to 3.0 times the total polymerization time during the former stages of the polycondensation step.

5. A production apparatus for polytrimethylene terephthalate comprising an esterification bath and polymerization vessels for performing polycondensation, wherein:
a plurality of polymerization vessels are serially connected;
a polymerization vessel in the final stage has a twin-shaft agitator; and
each polymerization vessel comprises a means for measuring the temperature of a molten polymer, a means for measuring the heating temperature of a polymerization vessel, and a means for controlling the heating temperature of a polymerization vessel so as to keep the temperature of a molten polymer at a predetermined level, and a means for controlling the temperature of a molten polymer in the polymerization vessel during the subsequent stage so that it is lower than the temperature of a molten polymer in the polymerization vessel during the former stage.

6. The production apparatus for polytrimethylene terephthalate according to claim 5, wherein the means for controlling the heating temperature of the polymerization vessel during the final stage is to control the heating temperature of the polymerization vessel so that the temperature of the molten polymer is 250° C. or lower.

7. The production apparatus for polytrimethylene terephthalate according to claim 5, wherein the volume of the charged molten polymer in the polymerization vessel during the final stage is 0.5 to 3.0 times the total volume of the charged molten polymer in the polymerization vessel during the former stages.

8. The production apparatus for polytrimethylene terephthalate according to claim 6, wherein the volume of the charged molten polymer in the polymerization vessel during the final stage is 0.5 to 3.0 times the total volume of the charged molten polymer in the polymerization vessel during the former stages.
